(19) United States
(12) Patent Application Publication
(10) Pub. No.: US 2023/0173630 A1
(43) Pub. Date: Jun. 8, 2023

(54) DUST COLLECTOR ATTACHMENT

(71) Applicant: MAKITA CORPORATION, Anjo-shi (JP)

(72) Inventors: Shin SUGIURA, Anjo-shi (JP); Kiyonobu YOSHIKANE, Anjo-shi (JP); Hikaru SUNABE, Anjo-shi (JP)

(73) Assignee: MAKITA CORPORATION, Anjo-shi (JP)

(21) Appl. No.: 17/983,853

(22) Filed: Nov. 9, 2022

(30) Foreign Application Priority Data
Dec. 3, 2021 (JP) 2021-196728

(51) Int. Cl. B23Q 11/00

(52) U.S. Cl. CPC B23Q 11/0046

(57) ABSTRACT

A dust collector attachment for use with a drilling tool is configured to suck dust generated during the drilling operation. The dust collector attachment includes a suction nozzle and a detection part The suction nozzle has an insertion hole that is configured to allow a tool accessory removably held by the drilling tool to be inserted therethrough, and a suction port through which the dust is sucked. The detection part includes a sensor that is configured to detect metal within a detection range.

### CROSS-REFERENCE TO RELATED APPLICATION

The present application claims priority to Japanese patent application No. 2021-196728 filed on Dec. 3, 2021, the contents of which are hereby fully incorporated herein by reference.

### TECHNICAL FIELD

The present disclosure relates to a dust collector attachment for use in sucking dust that is generated by a drilling tool during a drilling operation.

### BACKGROUND

When a drilling tool performs a drilling operation on an object (for example, a concrete wall) that contains metal (for example, a rebar) buried (embedded) inside, a tool accessory (for example, a drill bit) may hit the metal and may be locked. In this regard, known portable detection devices for buried objects enable users to check the position of the buried object in advance (see, for example, Japanese Unexamined Patent Application Publication No. 2020-134492).

### SUMMARY

The above-explained detection device can facilitate checking of the buried objects in advance. On the other hand, working efficiency of the drilling operation may be decreased.

Considering the above-explained situation, one non-limiting object of the present disclosure is to provide techniques that enable checking of a buried object while suppressing decrease in working efficiency of a drilling operation.

A non-limiting aspect of the present disclosure herein provides a dust collector attachment for use with a drilling tool. The dust collector attachment is configured to suck dust generated during a drilling operation. The dust collector attachment includes a suction part (e.g., a suction nozzle) and a detection part. The suction part has an insertion hole and a suction port. The insertion hole is an opening that is configured to allow a tool accessory detachably held by the drilling tool to be inserted therethrough. The suction port is an opening through which the dust is sucked. The detection part includes a sensor that is configured to detect metal within a detection range.

According to this aspect, because the dust collector attachment that is used in the drilling operation includes the sensor, which is capable of detecting metal, a user can search metal buried in a drilling object, using the dust collector attachment. Thus, the user is not required to operate a separate detection device for buried objects to search the metal first and then to prepare the dust collector attachment for the drilling operation. Therefore, decrease in working efficiency can be suppressed. When drilling a plurality of holes in the drilling object, in particular, the working efficiency can be remarkably improved, compared with a case in which the user needs to use the separate detection device.

### BRIFF DESCRIPTION OF THE DRAWINGS

FIG. 1 is an overall perspective view of a dust collecting system according to a first embodiment.

FIG. 2 is a cross-sectional view of the dust collecting system.

FIG. 3 is a view showing a suction nozzle and a sensor unit as viewed from the rear side

FIG. 4 is a cross-sectional view taken along line IV-IV in FIG. 3.

FIG. 5 is an overall perspective view of a dust collecting system according to a second embodiment.

FIG. 6 is a view showing a dust collector attachment as viewed from rear side.

### DETAILED DESCRIPTION OF THE EMBODIMENTS

In one non-limiting embodiment according to the present disclosure, the sensor may be disposed adjacent to (in the vicinity of) the suction part (especially, the insertion hole). According to this embodiment, the sensor is capable of detecting the metal buried in the drilling object in the vicinity of a position at which the tool accessory is disposed. it is noted that the shorter a distance between the sensor (a detection coil, for example) and the suction part (especially the insertion hole) is, the more preferable it is.

In addition or in the alternative to the preceding embodiment, the detection part ay include an annular part that is disposed around the insertion hole of the suction part. Further, the detection part may be connected to the suction part such that a center of the annular part substantially coincides with a center of the insertion hole. According to this embodiment, the suction part and the detection part can be arranged within a relatively compact space.

In addition or in the alternative to the preceding embodiment, the detection part may be removable form the dust collector attachment. According to this embodiment, the user can use the dust collector attachment without the detection part when it is not necessary to search buried metal. Therefore, operability can be improved.

In addition or in the alternative to the preceding embodiment, the dust collector attachment may further include a first operation part that is configured to be manipulated by a user to reset a detection reference of the sensor. According to this embodiment, the user can manipulate the first operation part after the sensor detects the tool accessory, which is made of metal, so that the tool accessory will not be detected afterwards.

In addition or in the alternative to the preceding embodiment, the dust collector attachment may further include an indication part. An axis that extends through the insertion hole may be defined for the suction part. For example, this axis may be an axis that passes through the center of the insertion hole, or may be an axis that substantially coincides with a longitudinal axis of the tool accessory when the tool accessory is inserted into the insertion hole. The sensor may be configured to detect relative positional relationship between the metal within the detection range and the sensor. The indication part may be configured to indicate, based on a detection result of the sensor, (i) first information relating to a distance between the metal and the sensor, and (ii) second information relating to a distance between the metal and the axis in a direction that is perpendicular to the axis. According to this embodiment, by the first information and the second information indicated by the indication part, the user can recognize not only whether the metal exists in the vicinity of the sensor, but also whether the metal is buried at a target point at which the tool accessory aims. Therefore, the user can more appropriately decide as to whether it is appropriate to drill a hole at the target point.

In addition or in the alternative to the preceding embodiment, the dust collector attachment may be attachable to and detachable from a tool body of the drilling tool. According to this embodiment, the user can hold the dust collector attachment with the sensor together with the drilling tool and thus, working efficiency can be further improved.

In addition or in the alternative to the preceding embodiment, the dust collector attachment may be attachable to and detachable from a dust collector that is configured to operate independently (separately) from the drilling tool. According to this embodiment, the dust collector attachment attached to the dust collector can be used without respect to the type of the drilling tool.

In addition or in the alternative to the preceding embodiment, the dust collector attachment may further include a second operation part that is configured to be manipulated by a user to activate the dust collector. According to this embodiment, the user can search metal by utilizing the dust collector attachment and can also activate the dust collector by manipulating the second operation part on the dust collector attachment. Thus, working efficiency can be further improved.

In addition or in the alternative to the preceding embodiment, a dust collecting system may include a drilling tool and the dust collector. The drilling tool may include a (i) motor, (ii) a control device that is configured to control driving of the motor and (iii) a tool body that houses the motor and the control device. The dust collector attachment may be detachably attached to the tool body of the drilling tool. The sensor of the dust collector attachment may be configured to detect a distance between the metal within the detection range and the sensor. The control device of the drilling tool may be configured not to drive the motor when the distance between the metal and the sensor is shorter than a specified distance. According to this embodiment, when the motor is not driven in response to an operation for activating the motor, the user can recognize, without any indication or notification, that the tool accessory may possibly hit (interfere with) the metal. Further, because the tool accessory is not driven, the possibility that the tool accessory is hit by the metal and locked can be reliably decreased.

Non-limiting, representative embodiments of the present disclosure are hereinafter explained with reference to the drawings.

### First Embodiment

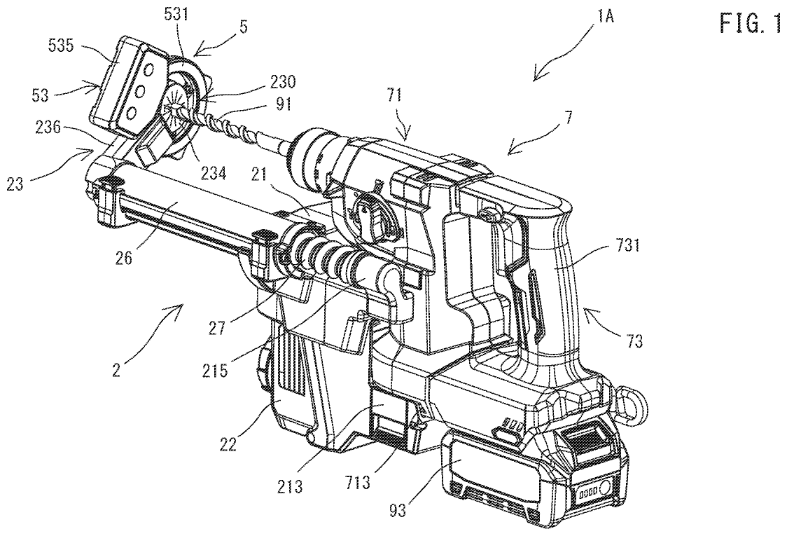

A dust collecting system 1A according to a first embodiment is specifically explained with reference to FIG. 1 to FIG. 4.

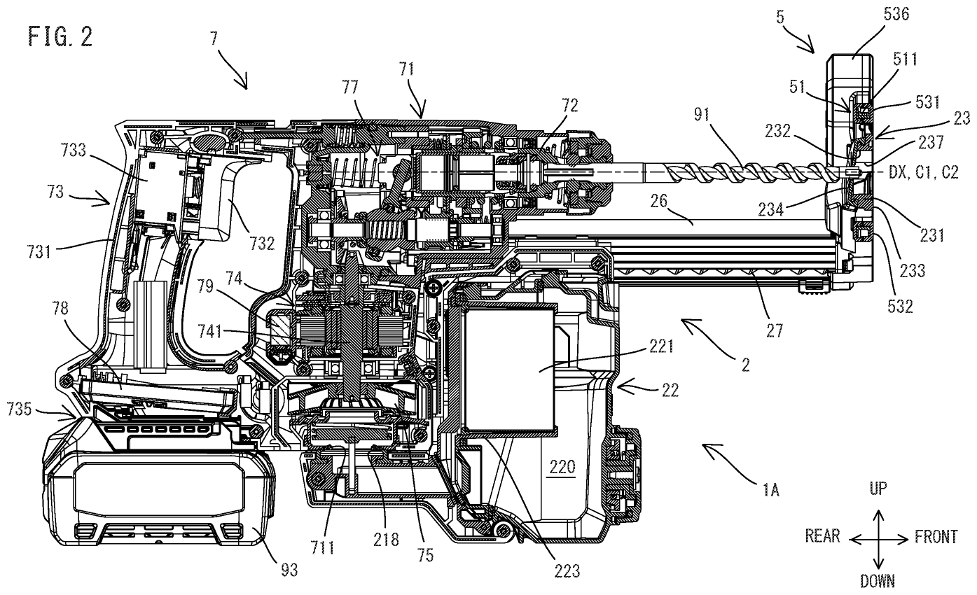

First, a general structure of the dust collecting system 1A is explained. As shown in FIG. 1 and FIG. 2, the dust collecting system 1A includes a drilling tool 7 and a dust collector attachment (dust extractor attachment) 2. The drilling tool 7 is an example of an electric power tool that is configured to perform a drilling operation by rotationally driving a tool accessory 91 (for example, a drill bit). The dust collector attachment 2 is a device (apparatus) that is configured to be detachably attached to the drilling tool 7 to suck and collect (extract) dust that is generated by the drilling tool 7 during the drilling operation.

In the dust collecting system 1A of this embodiment, a fan 75 is rotated while a motor 74 of the drilling tool 7 is driven and thus, an air flow for sucking dust is generated. A tool body 71 of the drilling tool 7 has an intake port 711 that communicates with a discharge port 218 of the dust collector attachment 2 when the dust collector attachment 2 is attached to the drilling tool 7. A dust storage space 220 is defined within the dust collector attachment 2. A filter 221 is disposed in the dust storage space 220. Further, an air flow passage is defined within the dust collector attachment 2. The air flow passage extends from a suction port 237, through which the dust is sucked, to the discharge port 218 by way of the dust storage space 220. The dust is introduced with air into the dust collector attachment 2 through the suction port 237, reaches the dust storage space 220, and then is separated from the air flow by the filter 221 and stored within the dust storage space 220. On the other hand, the air passes through the filter 221, reaches the discharge port 218, and flows into the tool body 71 of the drilling tool 7. Then, the air is discharged from discharge ports (not shown) of the tool body 71 to the outside of the tool body 71.

The detailed structures of the drilling tool 7 and the dust collector attachment 2 are now explained in this order.

First, the structure of the drilling tool 7 is described. As shown in FIG. 1 and FIG. 2, the drilling tool 7 includes a tool body 71 that is configured to removably receive the dust collector attachment 2, a handle 73 that is connected to the tool body 71, a tool holder 72, a motor 74, a fan 75 and a drive mechanism 77. The tool holder 72, the motor 74, the fan 75 and the drive mechanism 77 are disposed within the tool body 71.

The tool holder 72 is configured to removably hold the tool accessory 91 (for example, a drill bit). The tool holder 72 is supported within the tool body 71 to be rotatable around a drive axis DX. The tool accessory 91 is attached to the tool holder 72 such that a longitudinal axis of the tool accessory 91 coincides with the drive axis DX. The tool holder 72 is rotated around the drive axis DX by means of the drive mechanism 77, in response to the rotation of the motor 74. Accordingly, the tool accessory 91 is rotated and the drilling operation is performed. Further, in response to the driving of the motor 74, the fan 75, which is fixed around an output shaft 741 of the motor 74, is rotated and the air flow for sucking the dust is thus generated, as described above.

Although not explained in detail, the drilling tool 7 of this embodiment is a rotary hammer (hammer drill). The drive mechanism 77 is thus capable of rotating the tool accessory 91 and striking (hammering) the tool accessory 91. The drilling tool 7, however, may be only configured to rotate the tool accessory 91.

The handle includes a grip part 731 to be held by a user. A trigger 732 is provided at one end portion of the grip part 731. The trigger 732 is configured to be manually depressed by the user. The grip part 731 is spaced apart from the tool body 71 and extends in a direction that is perpendicular to the drive axis DX, In the following explanation, for the sake of convenience, the extending direction of the drive axis DX is defined as a front-rear direction of the drilling tool 7. In the front-rear direction, the side on which the tool accessory 91 is attached to the tool body 71 is defined as a front side, and the opposite side (the side on which the handle 73 is disposed) defined as a rear side. The direction that is perpendicular to the drive axis DX and that generally corresponds to the extending direction of the grip part 731 is defined as an up-down direction of the drilling tool 7. In the up-down direction, the side on which the trigger 732 is disposed is defined as an upper side and the opposite side is defined as a lower side. The direction that is perpendicular both to the front-rear direction and the up-down direction is defined as a right-left direction.

A switch 733 and a controller 78 are disposed within the handle 73. The switch 733 is configured to be turned ON in response to depressing operation of the trigger 732. The controller 78 is configured to control the operation of the drilling tool 7. The controller 78 of this embodiment includes a microcomputer, which includes a CPU, a memory and so on. The controller 78, however, may include a control circuit other than the microcomputer. Further, a battery mounting part 735 is provided on a lower end portion of the handle 73. A rechargeable battery 93 can be removably mounted on the battery mounting part 735. Thus, the drilling tool 7 is driven by electricity supplied from the battery 93. Alternatively, the drilling tool 7 may be driven by electricity supplied from any external commercial power source via an electric power cord.

Further, in this embodiment, the drilling tool 7 includes a wireless unit 79 that is configured to wirelessly communicate with an external device (apparatus). The wireless unit 79 may be configured to be removably disposed within the tool body 71. Otherwise, the wireless unit 79 may be fixedly disposed within. the tool body 71. Although the structure of the wireless unit 79 is not shown in detail in the drawings, the wireless unit 79 includes at least an antenna and a transmitter-receiver circuit. The wireless unit 79 is electrically connected to the controller 78, and configured to wirelessly transmit and receive signals to and from an external device in response to control signals from the controller 78.

The dust collector attachment 2 is now explained. For the sake of convenience, the directions of the dust collector attachment 2 are defined with reference to the directions of the drilling tool 7 when the dust collector attachment 2 is attached to the drilling tool 7.

As shown in FIG. 1, the dust collector attachment 2 includes a main body 21, a dust box 22, a suction nozzle 23, a slide part 26, a hose 27 and a sensor unit 5.

The main body 21 is configured to be attachable to and detachable from the tool body 71 of the drilling tool 7. The main body 21 of this embodiment is configured such that the main body 21 abuts on front faces of a central portion and a lower end portion of the tool body 71 as well as on a lower face of the lower end portion of the tool body 71. A receiving part 713 is provided on each of left and right walls of the lower end portion of the tool body 71. Correspondingly, the main body 21 of the dust collector attachment 2 has engagement parts 213, which are engageable with the receiving parts 713 of the tool body 71. The engagement parts 213 are provided on portions of the main body 21 that are placed at the left side and the right side of the lower end portion of the tool body 71 when the dust collector attachment 2 is attached to the tool body 71. The dust collector attachment 2 is attached to the tool body 71 by engagement between the engagement parts 213 and the receiving parts 713.

In this embodiment, the receiving parts 713 are each formed as a recess (groove) and the engagement parts are each formed as a hook (latch) that is engageable with the recess. Nevertheless, the main body 21 can be detachably attached to the tool body 71 by means of any other known structure. Further, the tool body 71 and the main body 21 may be engaged with and connected to each other at least at one position other than the above-explained positions.

As shown in FIG. 2, in this embodiment, the intake port 711 is formed in the lower end portion of the tool body 71 (more specifically, directly below the output shaft 741 of the motor 74). Correspondingly, the discharge port 218 is formed in a portion that abut on the lower face of the lower end portion of he tool body 71 when the dust collector attachment 2 is attached to the tool body 71.

The dust box 22 is a container that is configured to store the dust. The dust box 22 is removably connected to the main body 21. A filter 221 is disposed within the dust box 22 and is held by a filter holder 223. The inner space of the dust box 22 functions as the dust storage space 220. A discharge passage is defined within the main body 21. The air that has passed through the filter 221 flows through the discharge passage to reach the discharge port 218.

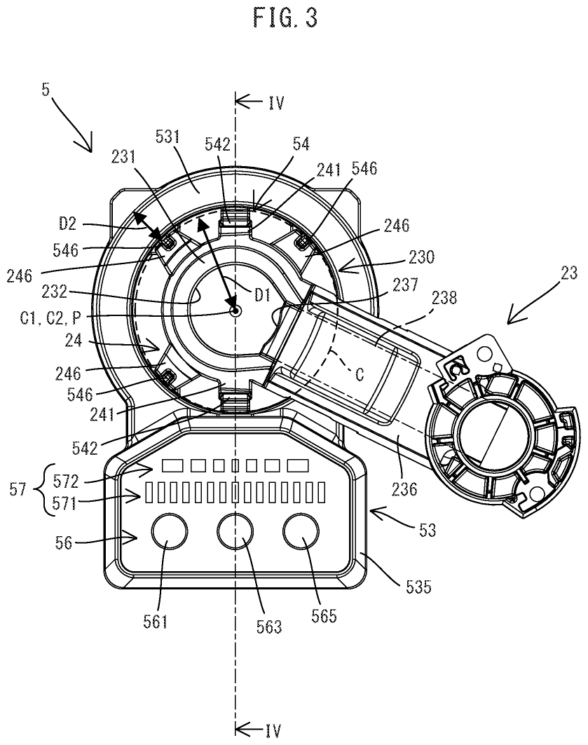

As shown in FIG. 2 and FIG. 3, the suction nozzle 23 is a portion to be disposed such that the suction nozzle 23 is partly in contact with an object to be drilled (hereinafter simply referred to as a drilling object) in the vicinity of the tool accessory 91. In this embodiment, the suction nozzle 23 includes an annular (ring-shaped) part 231, an arm part 236 and a connecting part 24. The suction nozzle 23 of this embodiment is made of synthetic resin (polymer, plastic).

The annular part 231 is generally shaped like a ring (or a short hollow cylinder), and has an insertion hole 232 at its center. A front face 233 of the annular part 231 functions as a face (a contact face) that abuts (contacts) the surface of the drilling object during the drilling operation. The insertion hole 232 is a penetration hole (through hole) that allows the tool accessory 91 to be inserted therethrough. The insertion hole 232 of this embodiment has a circular cross-section. When the dust collector attachment 2 is attached to (mounted on) the drilling tool 7, the tool accessory 91 extends through substantially the center of the insertion hole 232. Thus, the drive axis DX of the drilling tool 7 (the longitudinal axis of the tool accessory 91) and a central axis C1 of the annular part 231 (of the insertion hole 232) substantially coincides with each other. A rubber cap 234 is detachably mounted on the annular part 231 (see FIG. 1 and FIG. 2). The cap 234 has slits that extend radially outward from it center.

The arm part 236 is a tubular portion that is connected to a portion of the annular part 231. The arm part 236 extends linearly and radially outward of the annular part 231. The opening at one end of the arm part 236 communicates with the insertion hole 232. Air and dust flows into the suction nozzle 23 through this opening (hereinafter referred to as a suction port 237). The inner space of the arm part 236 functions as a suction passage 238. The air and the dust sucked from the suction port 237 pass through the suction passage 238. The suction passage 238 extends from the suction port 237 to the other end of the arm part 236 (an end opposite to the annular part 231).

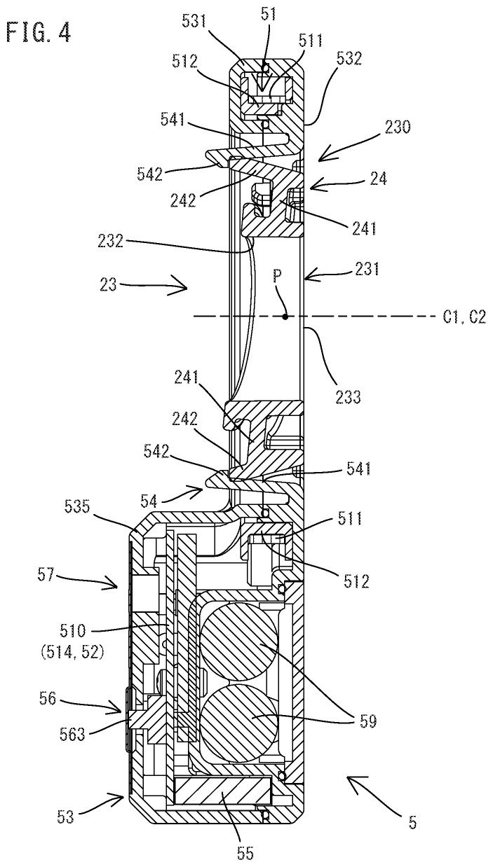

As shown in FIG. 3 and FIG. 4, the connecting part 24 is detachably connected to a sensor unit 5. The connecting part 24 has two first projections 241 and three second projections 246. The first projections 241 and second projections 246 each project radially outward from an outer circumferential surface of the annular part 231. The connecting part 24 and the annular part 231 together form a distal end part 230 of the suction nozzle 23. The two first projections 241 are along the diameter of the annular part 231. An engagement piece 242, which is shaped like a rectangular strip, is connected to a distal end of each first projection 241. The engagement piece 242 is spaced apart from and radially outward of the outer circumference of the annular part 231, and extends in the front-end direction. Each of the second projections 246 has a recess formed at its distal end. The connecting structure between the connecting part 24 and the sensor unit 5 will be explained in detail later.

As shown in FIG. 1 and FIG. 2, the suction nozzle 23 of this embodiment is connected to the slide part 26 and thus supported by the slide part 26. The slide part 26 is formed as a hollow body that linearly extends in the front-rear direction at the left side of the main body 21. The slide part 26 is supported by the main body 21 to be slidable in the front-rear direction. A base end part (i.e., an end portion of the arm part 236) of the suction nozzle 23 is secured to a distal end portion of the slide part 26.

The hose 27 is a flexible tubular member. One end of the hose 27 is connected to the base end part of the suction nozzle 23 within the front end portion of the slide part 26. The hose 27 extends in the slide part 26. The other end of the hose 27 is connected to a tubular part 215 provided on the rear end portion of the main body 21. The inner space of the hose 27 communicates with the inner space of the suction nozzle 23 (i.e., the suction passage 238) and with the inner space of the tubular part 215. Further, although not shown in detail, the inner space of the tubular part 215 communicates with the dust storage space 220 via a passage defined within the rear end portion of the main body 21. Thus, a dust transfer passage, which connects the suction passage 238 to the dust storage space 220, is defined within the hose 27 and the main body 21.

Although not shown in detail, a coil-shaped biasing member is buried in the hose 27. Owing to this biasing member, the suction nozzle 23, the slide part 26 and the hose 27 is always biased frontward. As the drilling operation proceeds with the annular part 231 of the suction nozzle 23 abutting the drilling object, the suction nozzle 23, the slide part 26 and the hose 27 rove rearward relative to the main body 21 and the drilling tool 7 against the biasing force of the biasing member.

As shown in FIG. 3 and FIG. 4, the sensor unit 5 is a unit having a sensor 51. The sensor unit 5 is detachably connected (attached) to the suction nozzle 23 such that the sensor unit 5 is adjacent to the distal end part 230 (the insertion hole 232) of the suction nozzle 23. in this embodiment, the sensor unit 5 includes the sensor 51, a control part 52, a housing 53, a wireless communication part 55, an operation part 56 and an indication part 57.

The sensor 51 is configured to detect metal within a specified detection range in a contactless manner. Further, as to the metal within the detection range, the sensor 51 is capable of detecting a relative positional relationship between the metal and the sensor 51. Any known sensor can be employed as the sensor 51. For example, one of an electromagnetic induction type, a magnetic type and a capacitive type may he employed for the detection.

In this embodiment, for example, the sensor 51 is an electromagnetic induction sensor having a known structure. The sensor 51 includes a detection coil 511 and a circuit part 514 that is electrically connected to the detection coil 511. In this embodiment, the detection coil 511 is wound around a cylindrical spool 512. Although not shown in detail, the circuit part 514 includes various circuits (e.g., an oscillator circuit, a detection circuit and an output circuit) mounted on a board (substrate) 510. The circuit part 514 is configured to determine the relative positional relationship between the detected metal and the sensor 51, and outputs a signal that indicates the positional relationship to the control part 52. The circuit part 514 of this embodiment is configured to determine, for example, the relative positional relationship of the detected metal and a reference point P, which is defined on a central axis C2 of the detection coil 511 (or of the spool 512).

The control part 52 is configured to control operation of the sensor unit 5. In this embodiment, the control part 52 is a microcomputer having CPU and a memory. The control part 52 is mounted on the board 510, on which the circuit part 514 of the sensor 51 is also mounted. Alternatively, the control part 52 may be a control circuit other than the microcomputer. Further, the control part 52 and the circuit part 514 may be separately mounted on different boards (substrates). The control part 52 is electrically connected to the circuit part 514 of the sensor 51, the wireless communication part 55, the operation part 56 and the indication part 57. The operation of the control part 52 will be explained later.

The housing 53 is a hollow body that houses the sensor 51. The housing 53 of this embodiment is made of synthetic resin (polymer, plastic). The housing 53 includes a coil housing part 531, a circuit housing part 535 and a connecting part 54.

The coil housing part 531 is an annular portion that houses the detection coil 511 (the spool 512) of the sensor 51. More specifically, the coil housing part 531 is a hollow portion that is shaped like a substantially circular ring as viewed from the front side or from the rear side, and that has a thickness in the front-rear direction. The inner diameter of the coil housing part 531 is larger than the outer diameter of the distal end part 230 of the suction nozzle 23 (the diameter of the circle C (see FIG. 3) that defines the outer edge of the distal end part 230). The coil housing part 531 is connected to the annular part 231 of the suction nozzle 23 by means of the connecting parts 24, 54. The coil housing part 531 is disposed radially outward of the annular part 231 and concentric with the annular part 231. The central axis C2 of the coil housing part 531 and the detection coil 511 substantially coincides with the central axis C1 of the annular part 231. Further, when the dust collector attachment 2 is attached to the drilling tool 7, the detection coil 511 surrounds (encircles) the tool accessory 91. Thus, the above-explained reference point P of the sensor 51 is substantially on the drive axis DX (see FIG. 2). To put it differently, the drive axis DX substantially passes through the reference point P.

A distance D2 from the circle C defining the outer edge of the distal end part 230 of the suction nozzle 23 to the outer edge of the coil housing part 531 (specifically, the annular part) is shorter than the radius D1 of the circle C. Thus, the coil housing part 531 is accommodated in a relatively small region around the distal end part 230 of the suction nozzle 23 in the radial direction of the annular part 231. Accordingly, the distal end part 230 and the coil housing part 531 are within a relatively compact space. Further, the detection coil 511 is adjacent to the insertion hole 232, into which the tool accessory 91 is inserted. Therefore, the sensor 5 can detect the metal that is buried in the drilling object in the vicinity of a target point aimed by the tool accessory 91.

Further, the front face 532 of the coil housing part 531 and the front face 233 of the annular part 231 of the suction nozzle 23 are substantially in the same plane. The front face 532 of the coil housing part 531 and the front face 233 of the annular part 231 each function as the face (the contact face) that abuts (contacts) the outer surface of the drilling object during the drilling operation. The front face 532 of the coil housing part 531 may, however, be located rearward of the front face 233 of the annular part 231 in the front-rear direction.

The detection coil 511 of the sensor 51 and the reference point P are in the vicinity of the front face 532 (the contact face) of the coil housing part 531 in a direction perpendicular to the front face 532 (the contact face). In this embodiment, the front end of the detection coil 511 (an end located on the side closer to the drilling object) and the reference point P are located frontward of the rear end of the annular part 231 of the suction nozzle 23. Thus, the reference point P is between the front end and the rear end of the annular part 231 of the suction nozzle 23 in the front-rear direction. Such arrangement of the detection coil 511 can reduce the possibility that the sensor 51 detects metal other than the metal buried in the drilling object. Further, the user can easily search the metal buried in the drilling object by placing the contact face in contact (abutment) with the drilling object.

The circuit housing part 535 is a portion that houses the board 510 of the sensor 51 and so on. The circuit housing part 535 has a box-like shape. The circuit housing part 535 is connected to a portion of the coil housing part 531, and projects radially outward from the coil housing part 531. The circuit housing part 535 houses the wireless communication part 55 and a battery 59, as well as the board 510. The battery 59 functions as a power source for the sensor unit 5 (see FIG. 4). The battery 59 may be disposable or rechargeable.

The connecting part 54 is a portion that is detachably connected to the connecting part 24 of the suction nozzle 23. The connecting part 54 includes two engagement pieces 541 provided on an inner face of the coil housing part 531 and four engagement projections 546, one of which is hidden by the arm part 236 in FIG. 3.

The two engagement pieces 541 are on the diameter of the coil housing part 531, corresponding to the engagement pieces 242 at the distal ends of the first engagement projections 241 of the connecting part 24 of the suction nozzle 23. Each of the engagement pieces 541 is shaped like a rectangular strip. A front end of each engagement piece 541 is connected to an inner face of the front end portion of the coil housing part 531 and the engagement piece 541 extends rearward in the front-rear direction. The engagement pieces 541 are located radially outward of the engagement pieces 242, respectively. The engagement piece 541 is flexible in the radial direction of the coil housing part 531. A claw 542 (projection) projects radially inward from a rear end portion of the engagement piece 541. The engagement piece 541 and the corresponding engagement piece 242 are snap-fit with each other in a state in which the claw 542 engages with the rear end (projecting end) of the engagement piece 242.

Three of the four engagement pieces 546 correspond to the three second projections 246 of the connecting part 24 of the suction nozzle 23. More specifically, each of the engagement projections 546 extends in the front-rear direction along the inner circumferential face of the coil housing part 531. The three of the four engagement pieces 546 are respectively fitted in the recesses formed in the distal ends of the second projection 246.

As explained above, the sensor unit 5 is connected to the suction nozzle 23 both by engagement between the first projections 241 (the engagement pieces 242) and the engagement pieces 541 and by engagement of the second projections 246 (the recesses at the distal ends) and the engagement pieces 546. The user can detach (remove) the sensor unit 5 from the suction nozzle 2.3 by bending the engagement pieces 541 radially outwards to disengage the claws 542 from the engagement pieces 242, and rearwardly moving the sensor unit 5 relative to the suction nozzle 23.

Further, the user can attach (connect) the sensor unit 5 to the suction nozzle 23 by positioning the connecting part 54 of the sensor unit 5 in the circumferential direction and then moving the sensor unit 5 forward relative to the connecting part 24 of the suction nozzle 23. It is noted that, owing to the structure of the above-explained connecting parts 24 and 54, an attachment position or an orientation of the sensor unit 5 relative to the suction nozzle 23 in the circumferential direction around the central axis C1, C2 can be changed by 180 degrees. Therefore, the user can change the orientation of the sensor unit 5 between a first orientation in which the circuit housing part 535 projects to the upper-left, as shown in FIG. 1, and a second orientation in which the circuit housing part 535 projects to the lower-right, depending on a working environment.

The wireless communication part 55 is configured to wirelessly communicate with an external device. Although not shown in detail, the wireless communication part 55 includes at least an antenna and one or more circuits for signal transmission and reception. The wireless communication part 55 is electrically connected to the control part 52 and wirelessly transmits and receives signals to and from the external device in accordance with the control signals from the control part 52.

The operation part 56 is provided on a rear face of the circuit housing part 535. The operation part 56 is configured to be manipulated by the user. More specifically, the operation part 56 is an input device into which various instructions relating to the operation of the sensor unit 5 are inputted by the user. The operation part 56 is electrically connected to the control part 52. In this embodiment, the operation part 56 includes a plurality of push buttons that are configured to be manually depressed by the user. More specifically, the operation part 56 includes a power-and-reset button 561, a wireless activation button 563 and a dust collector activation button 565.

The power-and-reset button 561 is configured to be manipulated in order to turn ON and OFF the sensor unit 5, and to reset a reference for detection (hereinafter referred to as a detection reference). When the power-and-reset button 561 is depressed while the power is OFF, the sensor unit 5 is turned ON. When the power-and-reset button 561 is kept depressed for a specified time period or more (i.e., long-pressed), while the power is ON, the sensor unit 5 is turned OFF. Further, when the power-and-reset button 561 is kept pressed for less than the specified time period (i.e., normally-pressed), while the power is ON, the detection reference is reset.

The tool accessory 91 is made of metal. Therefore, when the tool accessory 51 is within the detection range, the sensor 51 detects the tool accessory 91 as a metal within the detection range. In this regard, in a case where the control part 52 recognizes a signal indicating normal-pressing from the power-and-reset button 561, the control part 52 resets (adjusts) the detection reference in order to exclude the metal (e.g., the tool accessory 91) detected at the time of such recognition from further detection. Thus, pressing the power-and-reset button 561 while the sensor 51 detects the tool accessory 91 enables the sensor 51 to detect metal other than the tool accessory 91.

The wireless activation button 563 is configured to be manipulated in order to cause the control part 52 to activate the wireless communication part 55 so as to enable wireless communication with an external device. As explained above, the drilling tool 7 of this embodiment includes the wireless unit 79. When the dust collector attachment 2 is attached to the drilling tool 7, the wireless activation button 563 is pressed and the wireless unit 79 is also activated in the drilling tool 7, the drilling tool 7 is recognized as a communication partner. Through such a procedure, wireless communication between the wireless communication part 55 and the wireless unit 79 becomes possible. This procedure is also referred to as “pairing”, which pertains to a known art, and thus explanation thereof is omitted here. It is noted that, in a case where, another external device (e.g., an external dust collector), not the drilling tool 7, is within a specified communication range and the same operation for the activation is performed, the wireless communication part 55 is also able to communicate with the external device.

The dust collector activation button 565 is configured to be manipulated in order to activate an external dust collector to start. As explained above, when the dust collector activation button 565 is pressed while the wireless communication part 55 can wirelessly communicate with the external dust collector (in a state where the pairing is completed), the control part 52 causes the wireless unit 55 to transmit a specified signal to the dust collector. The dust collector operates in response to the signal that is thus transmitted from the sensor unit 5.

The indication part 57 is disposed adjacent to the operation part 56 on the rear face of the circuit housing part 535. The indication part 57 is configured to indicate information that corresponds to a detection result of the sensor 51. In this embodiment, the indication part 57 indicates two types of information (first information and second information). For this purpose, the indication part 57 includes a first indicator 571 that is configured to indicate the first information and a second indicator 572 that is configured to indicate the second information. The first information is related to a distance between the detected metal and the sensor 51 (specifically, the reference point P). The second information is related as to whether the detected metal is on the central axis C2 of the detection coil 511 or within a specified range around the central axis C2. It is noted that the second information may also be defined as information related to a distance between the metal and the central axis C2 in a direction that is perpendicular to the central axis C2 (i.e., a degree of positional deviation from the central axis C2).

The first indicator 571 includes a plurality of LED lights, for example. The control part 52 determines the distance between the detected metal and the reference point P based on the signal from the circuit part 514 of the sensor 51. The distance between the metal and the reference point P may be determined, for example, from magnitude (strength) of the signal outputted from the circuit part 514. The control pat 52 turns on at least one of the LED lights or blinks at least one of the LED lights in accordance with the distance. The control part 52 in this embodiment changes the number of the LED lights in accordance with the determined distance. Specifically, the control part 52 increases the number of the LED lights to be turned on as the distance becomes shorter, while the control part 52 decreases the number of the LED lights to be turned on as the distance becomes longer.

The second indicator 572 includes, for example, a plurality of LED lights. The control part 52 determines the distance between the detected metal and the central axis C2 in the direction that is perpendicular to the central axis C2 of the detection coil 511 (i.e., the central axis C1 of the annular part 231, the longitudinal axis of the tool accessory 91, or the drive axis DX) based on the signal from the circuit part 514 of the sensor 51. It is noted that the direction that is perpendicular to the central axis C2 of the detection coil 511 is also a direction that is substantially parallel to the front face 532 of the coil housing part 531 (i.e., the contact face). The control pat 52 turns on at least one of the LED lights or blinks at least one of the LED lights in accordance with the determined distance.

In this embodiment, when metal is on the central axis C2 or within the specified distance range from the central axis C2, the control part 52 turns on all of the LED lights of the second indicator 572, including the central LED light. The specified distance may be set, for example, to be equal to or slightly longer than the radius of the tool accessory 91 that has the largest diameter among all tool accessories that are attachable to the drilling tool 7. By thus setting the specified distance, the second indicator 572 can indicate that metal (for example a rebar) is buried substantially at a target point that is aimed by the tool accessory 91 (i.e., a position at which a hole is drilled). Further, the control part 52 turns on the LED lights aligned in a line in order, starting from two at both ends to the center, as the determined distance becomes shorter and gets closer to the specified distance.

Thus, the indication part 57 indicates not only the distance between the metal and the sensor 51 but also the degree of positional deviation, in the direction that is perpendicular to the central axis C2, between the metal and the target point the tool accessory 91 is aiming at. Therefore, the user can recognize not only whether the metal is in the vicinity of the sensor 51 but also whether the metal is buried at the target point aimed by the tool accessory 91. As a result, the user can more appropriately determine as to whether a hole can be drilled without any obstacle at the target point.

Usage and operation of the dust collecting system 1A are now explained.

In order to perform the drilling operation on a drilling object in which metal is buried (for example, a concrete wall or floor where rebars are buried), the user mounts the dust collector attachment 2, to which the sensor unit 5 is attached, onto the drilling tool 7. As explained above, the user manipulates the wireless activation button 563, so that the sensor unit 5 is paired with the drilling tool 7. The user manipulates the power-and-reset button 561 to reset the detection reference. And then, the user holds the dust collecting system 1A and causes at least a portion of the contact faces of the coil housing part 531 and the annular part 231 to abut (contact) the drilling object.

When the sensor 51 detects the metal, as explained above, the control part 52 causes the indication part 57 to indicate the first information and the second information based on the relative positional relationship between the metal and the sensor 51. Therefore, the user can visually check the indication part 57 to confirm the presence or absence of, and the relative position of the buried metal, if any. In a case that the user finds that metal is buried at the target point, the user can appropriately move the dust collecting system 1A, such that the tool accessory 91 aims at a target point that is suitable for drilling a hole, while visually checking the indication part 57.

Further, in this embodiment, the control part 52 causes the wireless communication part 55 to periodically transmit error signals to the wireless unit 79 of the drilling tool 7, which is the communication partner, while the distance between the metal and the sensor 51 is equal to or less than the specified distance. It is noted that this specified distance may be determined in advance and stored in the memory. Alternatively, the specified distance may be inputted through the operation part 56. The controller 78 of the drilling tool 7 does not drive the motor 74 while the controller 78 recognizes the error signals received via the wireless unit 79, even if the switch 733 is turned ON in response to pressing of the trigger 732. Such control can more reliably reduce the possibility that the tool accessory 91 is hit by the metal buried in the drilling object and thus locked.

When the controller 78 of the drilling tool 7 does not recognize the error signal, the controller 78 of the drilling tool 7 drives the motor 74 while the switch 733 is ON. Therefore, the drilling operation is performed as described above, and the dust is collected by utilizing the air flow generated by the fan 75.

Further, when it is not necessary for the user to search the metal buried in the drilling object, the user can detach the sensor unit 5 from the dust collector attachment 2. As a result, the size of the portion of the dust collector attachment 2 that is disposed around the tool accessory 91 in the radial direction becomes smaller. Thus, the operability of the dust collector attachment 2 (in particular, the operability during the drilling operation in a narrow space, for example) can be improved. Further, the user can separately (independently) use the detached sensor unit 5 to detect metal regardless of the drilling operation and thus it increases the convenience.

As explained above, according to the dust collecting system 1A of this embodiment, the dust collector attachment 2, which is configured to be attached to the drilling tool 7 and used for the drilling operation, includes the sensor 51 that is capable of detecting metal. Therefore, the user can search metal buried in the drilling object while holding the drilling tool 7 and the dust collector attachment 2 altogether, and then, the user can immediately start the drilling operation with the distal end part 230 of the suction nozzle 23 being placed at an appropriate position. Therefore, the working efficiency can be improved, compared with a case in which the user first manipulates a separate (discrete) detection device for buried objects to search metal and then picks up the drilling tool 7 to perform the drilling operation. When drilling a plurality of holes in the drilling object, in particular, the working efficiency can be remarkably improved in comparison with the above-described case in which the user uses the separate detection device.

### Second Embodiment

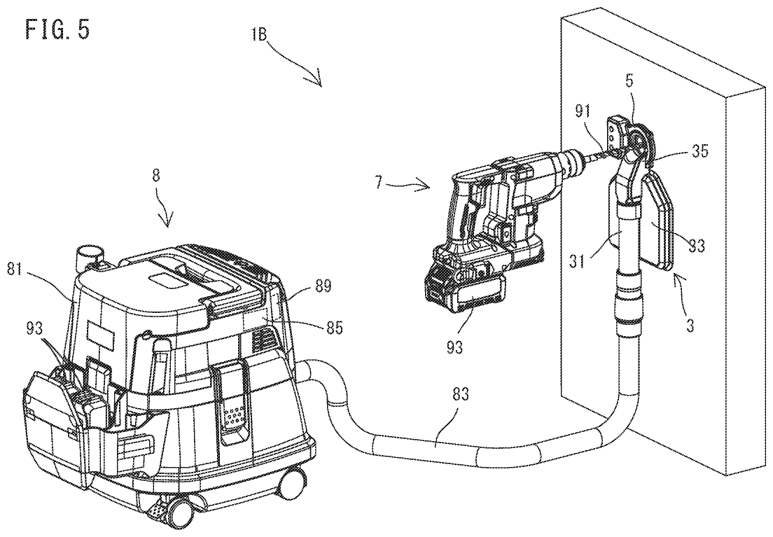

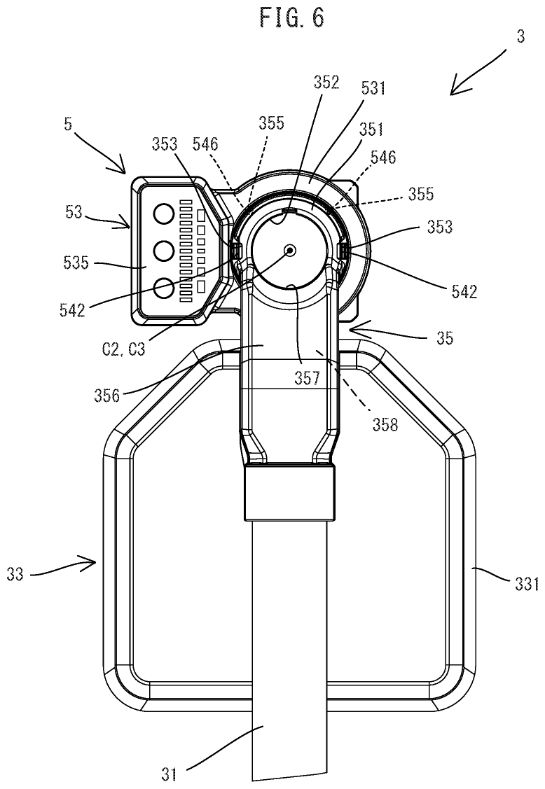

A dust collecting system 1B according to the second embodiment is hereinafter explained with reference to FIG. 5 and FIG. 6. In the following description, structures that are substantially identical to those of the first embodiment are given the same reference signs as in the first embodiment and are not or only briefly described.

The dust collecting system 1B includes a drilling tool 7, a dust collector (dust extractor) 8 and a dust collector attachment (dust extractor attachment) 3. The dust collector 8 is a known, independent (discrete, separate) device (apparatus) for collecting dust and can be used independently from the drilling tool 7. The dust collector attachment 3 is a device (apparatus) that is configured to be detachably attached to the dust collector 8 to suck and collect (extract) dust that is generated by the drilling tool 7 during drilling operation.

The structure of the dust collector 8 is now briefly explained. As shown in FIG. 5, the dust collector 8 includes a main body 81 and a hose 83 that is connected to the main body 81. Although not shown in detail, since it is well-known, the main housing 81 houses a motor and a fan that is configured to be rotated by the motor. The dust collector 8 is configured to suck dust via the hose 83 and collect (extract) the dust by utilizing an air flow generated by the fan. It is noted that, in this embodiment, the dust collector 8 is driven by electric power that is supplied from the rechargeable battery 93. However, the dust collector 8 may be driven by electric power that is supplied from an external commercial power source.

A controller 85 and a wireless unit 89 are housed within the main body 81. It is noted that the wireless unit 89 of the dust collector 8 has substantially the same structure with the structure of the wireless unit 79 of the drilling tool 7 (see FIG. 2). The controller 85 is configured to control driving of the motor in response to signals from the wireless unit 89.

The detailed structure of the dust collector attachment 3 is now explained. As shown in FIGS. 5 and 6, the dust collector attachment 3 includes a connecting pipe 31, a base part 33, a suction nozzle 35 and the sensor unit 5.

The connecting pipe 31 is a tubular portion that is attachable to and detachable from the hose 83 of the dust collector 8. The base part 33 is a portion that is configured to stick to a wall or a floor by utilizing suction force of the dust collector 8. The base part 33 has a known structure, and thus it is only briefly explained here. The base part 33 is cup-shaped and its circumferential edge is covered by a seal member 331 (e.g., by rubber). An inner space of the base part 33 communicates with an inner space of the connecting pipe 31. When the dust collector 8 is activated while the circumferential edge of the base part 33 is in abutment (contact) with the surface of the wall or the floor, the pressure inside the base part 33 becomes negative and the base part 33 sticks to the surface of the wall or the floor. Therefore, even if a user does not hold the dust collector attachment 3, the dust collector attachment 3 is held where it is placed.

The suction nozzle 35 is a portion that is configured to partly abut (contact) a drilling object in a vicinity of the tool accessory 91. The suction nozzle 35 is connected to the connecting pipe 31. The suction nozzle 35 of this embodiment includes an annular (ring-shaped) part 351 and an arm part 356. It is noted that the suction nozzle 35 is made of synthetic resin (polymer, plastic).

The annular part 351 is generally shaped like a ring (or a short hollow cylinder), and has an insertion hole 352 at its center. The annular part 351 has a central axis C3. One face of the annular part 351 functions as a face (a contact face) that abuts (contacts) a surface of the drilling object during the drilling operation. The insertion hole 352 is a penetration hole that allows the tool accessory 91 to be inserted therethrough. The insertion hole 352 has a circular cross-section. Although not shown, a rubber cap with slits extending radially outward from its center can be attached to the annular part 351, as in the first embodiment.

The coil housing part 531 of the sensor unit 5 is concentrically disposed around the annular part 351 (such that the central axis C2 coincides with the central axis C3). The sensor unit 5 is detachably connected to the annular part 351 via the connecting part 54. The outer diameter of the annular part 351 is slightly smaller than the inner diameter of the coil housing part 531. A plurality of grooves 353, 355 are formed on the outer circumferential face of the annular part 351. The grooves 353, 355 each extend in an extending direction of the central axis C2, C3. The engagement pieces 541 of the connection part 54 (see FIG. 4) are respectively disposed in the grooves 353. The claws 542 of the engagement pieces 541 respectively engage with recesses that are formed on a face that is opposite to the contact face of the annular part 351 in the extending direction of the central axis C2, C3. The engagement pieces 546 are respectively fitted in the grooves 355.

As described above, by engagement between the grooves 353 and the engagement pieces 541, and by engagement of the grooves 355 and the engagement pieces 546, the sensor unit 5 is connected to the suction nozzle 35. In the same manner as explained in the first embodiment, the user can attach the sensor unit 5 to the suction nozzle 35 or detach the sensor unit 5 from the suction nozzle 35.

The arm part 356 is a tubular portion that is connected to a portion of the annular part 351. The arm part 356 extends linearly and radially outward of the annular part 351. An opening at one end of the arm part 356 communicates with the insertion hole 352. Air and dust flows into the suction nozzle 35 through this opening (hereinafter referred to as a suction port 357). An inner space of the arm part 356 functions as a suction passage 358. The air and the dust sucked in from the suction port 357 pass through the suction passage 358. The suction passage 358 extends from the suction port 357 to the other end of the arm part 356 (an end opposite to the annular part 351). The other end of the arm part 356 is connected to the connection pipe 31 and the suction passage 358 communicates with the inner space of the connection pipe 31.

Usage and operation of the dust collecting system 1B are now explained.

In order to perform the drilling operation on a drilling object in which metal is buried (for example, a concrete wall or floor where rebars are buried), the user mounts the dust collector attachment 3, to which the sensor unit 5 is attached, onto the dust collector 8. As explained above, the user manipulates the wireless activation button 563, so that the sensor unit 5 is paired with the dust collector 8. The user places at least a portion of contact faces of the coil housing part 531 and the annular part 351 to abut (contact) the drilling object while the power of the sensor unit 5 is ON. Then the user visually checks the indication part 57 to confirm the presence or absence, and of the relative position of the metal, if any.

When the user presses the dust collector activation button 565 in a state in which the dust collector attachment 3 is at a desired position, the control part 52 of the sensor unit 5 causes the wireless communication part 55 to transmit a specified signal to the dust collector 8. When the controller 85 of the dust collector 8 recognizes the signal received by way of the wireless unit 89, the controller 85 starts driving of the motor. Air is sucked through the hose 83 in response to rotation of the fan and the base part 33 of the dust collector attachment 3 sticks to the surface of the drilling object and held at that position, as described above. Thus, the user can perform the drilling operation without holding the dust collector attachment 3. Thereafter, when the user presses the dust collector activation button 565, the wireless communication is performed and the controller 85 of the dust collector 8 stops the driving of the motor.

As explained above, according to the dust collecting system 1B of this embodiment, the dust collector attachment 3, which is attached to the dust collector 8 and used for the drilling operation, includes the sensor 51 that is capable of detecting metal. Therefore, the user can search metal buried in the drilling object by using the dust collector attachment 3 and then, the user can place the suction nozzle 35 at an appropriate position. Thus, working efficiency can be improved in comparison with a case in which the user first manipulates a separate (discrete) detection device for buried objects to search metal and then picks up the dust collector attachment 3 and places the suction nozzle 35 at the appropriate position.

Further, the dust collector attachment 3 is attachable to and detachable from the dust collector 8, which can be driven independently (separately) from the drilling tool 7. Therefore, the dust collector attachment 3 attached to the dust collector 8 can be used, regardless of a type of a drilling tool. Moreover, the dust collector attachment 3 (the sensor unit 5) has the dust collector activation button 565 and therefore, the user can activate the dust collector 8 by pressing the dust collector activation button 565 while searching the metal with the dust collector attachment 3. Thus, the working efficiency can be further improved.

Correspondences between elements or structures (features) of the above-explained embodiments and elements or structures (features) of the present disclosure or invention are described as follows. However, the features of the embodiment are merely exemplary, and do not limit the features of the present disclosure or invention. Each of the suction nozzles 23, 35 (the annular parts 231, 351) is an example of a “suction part”. The sensor unit 5 is an example of a “detection part”. The coil housing part 531 is an example of an “annular part”. The power-and-reset button 561 is an example of a “first operation part”. The controller 78 (specifically, the CPU) is an example of a “control device” of the drilling tool. The dust collector activation button 565 is an example of a “second operation part”.

Note that the above-explained embodiments are merely exemplary and the dust collector attachment according to the present disclosure is not limited to the exemplified dust collector attachments 2, 3. For example, following non-limiting modifications may be made. Further, at least one of these modifications may be employed in combination with at least one of the dust collector attachments 2, 3 exemplified in the embodiments and claimed features.

The structure of the dust collector attachment that is attachable to and detachable from the drilling tool may be changed in accordance with the structure of the drilling tool. For example, the dust collector attachment may include a dust collecting motor and a dust collecting fan. Further, the dust collector attachment, which is attachable to and detachable from the dust collector that is operable independently (separately) from the drilling tool, is not limited to the dust collector attachment that is configured to stick to the surface of the drilling object by the suction force of the dust collector. Alternatively, the dust collector attachment may be configured to be placed around (surround) the tool accessory that is attached to the drilling tool. In other words, the dust collector attachment may be structured as a so-called dust collecting cup. Moreover, the dust collector attachment with the drilling tool or with the dust collector may be configured to perform wire communication, instead of wireless communication. For example, the dust collector attachment may be configured to electrically connect to the drilling tool or to the dust collector by means of connectors and wires in response to attachment of the dust collector attachment to the drilling tool or to the dust collector.

The shape of the sensor unit 5 and the connecting structure of the sensor unit 5 and the suction nozzle 23, 35 can appropriately be changed. For example, in a case in which a sensor that requires no detection coil is employed, the housing 53 may include no annular part. The sensor unit 5 may be detachably connected to the suction nozzle 23, 35 by screw engagement, for example.

The power-and-reset button 561 may be separated into two individual buttons. Further, as in the case of the dust collector attachment 3 of the second embodiment that is not affected by the tool accessory 91 during the search of metal, for example, the power-and-reset button 561 may be omitted. The wireless activation button 563 and the dust collector activation button 565 may appropriately be omitted. As the operation part 56, for example, a rotary dial or a touch screen may be employed, instead of the push buttons.

Each of the first indicator 571 and the second indicator 572 of the indication part 57 may be structured by, for example, a single LED light or a display. Each of the first indicator 571 and the second indicator 572 may be configured to indicate a numerical value(s) that correspond to the distance, or to change colors of the LED light, depending on the distance. Further, the indication part 57 may be configured as a touch screen that is integral with the operation part 56, or may be configured as a speaker that indicates information by sound.

Further, in view of the nature of the present invention, the above-described embodiments, and the modifications thereof, the following Aspects can be provided. Any one of the following Aspects can be employed in combination with any one of the dust collector attachment 2, 3, of the above-described embodiments, the above-described modifications and the claimed features.

### Aspect 1

The suction part has a contact face that is configured to contact a drilling object and an opposite end that is located opposite to the contact face in a direction perpendicular to the contact face, and

at least a portion of the sensor (for example, a portion of a detection coil or a reference point of the sensor) is between the contact face of the suction part and the opposite end in the direction perpendicular to the contact face.

### Aspect 2

A distal end portion of the suction part has an annular shape and has the insertion hole at its center, and

a distance from an outer edge of the distal end part of the suction part to an outer edge of the annular part of the detection part is shorter than a radius of a circle that defines the outer edge of the distal end part of the suction part.

### Aspect 3

The drilling tool comprises a first communication part,

the dust collector attachment comprises a second communication part that is configured to communicate with the first communication part, and

the control device of the drilling tool is configured to control driving of the motor based on information that relates to the distance between the metal and the sensor and that is transmitted from the second communication part.

### Aspect 4

The dust collector attachment is configured such that an attachment position of the detection part relative to the suction part is changeable.

### DESCRIPTION OF REFERENCE SIGNS

1A, 1B: dust collecting system, 2: dust collector attachment, 21: main body, 213: engagement part, 215: tubular part, 218: discharge port 22: dust box, 220: dust storage space, 221: filter, 223: filter holder, 23: suction nozzle, 230: front tip end, 231: circular part, 232: insertion hole, 233: front face, 234: cap, 236: arm part, 237: suction port, 238: suction passage, 24: connecting part, 241, first projection, 242: engagement piece, 246: second projection, 26: slide part, 27: hose, 3: dust collector attachment, 31: connecting pipe, 33: base part, 331: seal member, 35: suction nozzle, 351: circular part, 352: insertion hole, 353: groove, 355: groove, 356: arm part, 357: suction port, 358: suction passage, 5: sensor unit, 51: sensor, 510: board, 511: detection coil, 512: spool, 514: circuit part, 52: control part, 53: housing, 531: coil housing part, 532: front face, 535: circuit housing part, 54: connecting part, 541: engagement piece, 542: claw, 546: engagement projection, 55: wireless communication part, 56: operation part, 561: power-and-reset button, 563: wireless activation button, 565: dust collector activation button, 57: indication part, 571: first indicator, 572: second indicator, 59: battery, 7: drilling tool, 71: tool body, 711: suction port, 713: receiving part, 72: tool holder, 73: handle, 731: grip part, 732: trigger, 733: switch, 735: battery mounting part, 74: motor, 741: output shaft, 75: fan, 77: drive mechanism, 78: controller, 79: wireless unit, 8: dust collector, 81: main body, 83: hose, 85: controller, 89: wireless unit, 91: tool accessory, 93: battery

What is claimed is:

1. A dust collector attachment for use with a drilling tool and configured to suck dust generated during a drilling operation, the dust collector attachment comprising:
a suction nozzle that has (i) an insertion hole that is configured to allow a tool accessory removably held by the drilling tool to be inserted therethrough, and (ii) a suction port through which the dust is sucked; and
a detection part that includes a sensor that is configured to detect metal within a detection range.

2. The dust collector attachment according to claim 1, wherein the sensor is disposed adjacent to the suction nozzle.

3. The dust collector attachment according to claim 1, wherein:
the detection part includes an annular part that is disposed around the insertion hole of the suction nozzle, and
the detection part is connected to the suction nozzle such that a center of the annular part substantially coincides with a center of the insertion hole.

4. The dust collector attachment according to claim 1, wherein the detection part is configured as a sensor unit that is removable from the dust collector attachment.

5. The dust collector attachment according to claim 1, further comprising:
a first operation part that is configured to be manipulated by a user to reset a detection reference of the sensor.

6. The dust collector attachment according to claim 1, further comprising:
an indication part,
wherein:
an axis that extends through the insertion hole is defined for the suction nozzle, the sensor is configured to detect relative positional relationship between the metal within the detection range and the sensor,
the indication part is configured to indicate, based on a detection result of the sensor, (i) first information relating to a distance between the metal and the sensor, and (ii) second information relating to a distance between the metal and the axis in a direction perpendicular to the axis.

7. The dust collector attachment according to claim 1, wherein the dust collector attachment is attachable to and detachable from a tool body of the drilling tool.

8. The dust collector attachment according to claim 1, wherein the dust collector attachment is attachable to and detachable from a dust collector, that is configured to operate independently from the drilling tool.

9. The dust collector attachment according to claim 8, further comprising:
a second operation part that is configured to be manipulated by a user to activate the dust collector.

10. The dust collector attachment according to claim 2, wherein:
the detection part includes a first annular part that is disposed around the insertion hole of the suction nozzle, and
the detection part is connected to the suction nozzle such that a center of the first annular part substantially coincides with a center of the insertion hole.

11. The dust collector attachment according to claim 10, wherein:
the detection part includes the sensor and a housing that houses the sensor, and configured as a sensor unit that is removable from the dust collector attachment,
the sensor includes (i) a detection coil and (ii) a circuit part that is electrically connected to the detection coil,
the housing includes (i) the first annular part that houses at least the detection coil and (ii) a first connecting part that is radially inward of the first annular part, and
the suction nozzle includes (i) a second annular part that has the insertion hole and that is disposed radially inward of the first annular part of the sensor unit and (ii) a second connecting part that is radially outward of the second annular part and that is removably connected to the first connecting part of the sensor unit.

12. The dust collector attachment according to claim 11, wherein:
the sensor unit includes a control part that is configured to control operation of the sensor unit, and
the housing includes a circuit housing part that projects radially outward from the first annular part and that houses the circuit part and the control part.

13. The dust collector attachment according to claim 12, wherein the first connecting part and the second connecting part are configured such that an attachment position of the sensor unit relative to the suction nozzle is changeable in a circumferential direction of the first connecting part and the second connecting part.

14. The dust collector attachment according to claim 13, further comprising:
an operation part that is provided on the circuit housing part of the sensor unit and that is configured to be manipulated by a user to reset a detection reference of the sensor.

15. The dust collector attachment according to claim 14, further comprising:
an indication part that is provided on the circuit housing part of the sensor unit,
wherein:
an axis that extends through the insertion hole is defined for the second annular part of the suction nozzles,
the sensor is configured to detect relative positional relationship between the metal within the detection range and the sensor,
the indication part is configured to indicate, based on a detection result of the sensor, (i) first information relating to a distance between the metal and the sensor, and (ii) second information relating to a distance between the metal and the axis in a direction perpendicular to the axis.

16. A dust collecting system comprising:
a drilling tool that includes (i) a motor, (ii) a control device that is configured to control driving of the motor and (iii) a tool body that houses the motor and the control device; and
the dust collector attachment according to claim 1 that is detachably attached to the tool body of the drilling tool,
wherein:
the sensor is configured to detect a distance between the metal within the detection range and the sensor, and
the control device of the drilling tool is configured not to drive the motor when the distance between the metal and the sensor is shorter than a specified distance.

17. The dust collector attachment according to claim 16, wherein:
the drilling tool includes a first communication part,
the dust collector attachment includes a second communication part that is configured to communicate with the first communication part, and
the control device of the drilling tool is configured to control the driving of the motor based on information that relates to the distance between the metal and the sensor and that is transmitted from the second communication part and received by the first communication part.
